(19) United States
(12) Patent Application Publication
(10) Pub. No.: US 2026/0251882 A1
(43) Pub. Date: Aug. 27, 2026

(54) OPTICAL SYSTEM AND OPTICAL DEVICE INCLUDING THE SAME

(71) Applicant: ZHEJIANG SUNNY OPTICS CO., LTD., Ningbo (CN)

(72) Inventors: Biran CHEN, Ningbo (CN); Xiaobin ZHANG, Ningbo (CN); Lin HUANG, Ningbo (CN)

(73) Assignee: ZHEJIANG SUNNY OPTICS CO., LTD., Ningbo (CN)

(21) Appl. No.: 19/387,395

(22) Filed: Nov. 12, 2025

(30) Foreign Application Priority Data
Feb. 21, 2025 (CN) 202510198738.1

(51) Int. Cl. G02B 9/06; G02B 13/00; G02B 27/01; G02B 27/28

(52) U.S. Cl. CPC G02B 9/06; G02B 13/003; G02B 27/286; G02B 27/0172

(57) ABSTRACT

An optical system and an optical device including the same are provided. The optical system includes a first element group and a second element group sequentially along an optical axis from a first side to a second side. The first element group includes a reflective polarizing element, a first quarter-wave plate, a first lens, and a partially reflective element. The second element group comprises a second lens, a second quarter-wave plate, a polarizer, and a display. The optical system is configured to satisfy the following relationships: 0.5<fz1/fz2<1.4 and 5.30≤(CT2+CTQ2+CTL)/ΔL≤7.71.

### CROSS-REFERENCE TO RELATED APPLICATION

This application claims priority to Chinese patent application No. 202510198738.1, filed on Feb. 21, 2025, the content of which is hereby incorporated by reference in its entirety.

### TECHNICAL FIELD

The present disclosure relates to the field of optical elements, and in particular, to an optical system and an optical device including the same.

### BACKGROUND

With the continuous development of virtual reality technology, a mainstream solution for a visual system of a VR head-mounted display device has been changed from a Fresnel solution to a catadioptric solution. The catadioptric solution has advantages such as a shorter total system length, improved display performance, and diopter adjustment functionality. However, a light path in a catadioptric optical system is relatively complex, and variations in assembly positions of lenses and reflective elements may result in different performances of the optical system. The current catadioptric visual system of the VR head-mounted display device still has some disadvantages. Firstly, an existing design usually uses a relatively large quantity of lenses or thicker lenses, which causes an increase in volume and weight of the system, thereby affecting wearing comfort of the user. Secondly, although the existing design can achieve diopter adjustment, it often struggles to maintain image quality while achieving a compact and lightweight structure.

Therefore, properly designing the structural arrangement of lenses, reflective elements, and displays to develop a catadioptric optical system with a diopter adjustment functionality and a compact structure has become one of the key research focuses in the field.

### SUMMARY

In a first aspect of the present disclosure, an optical system is provided. The optical system includes a first element group and a second element group sequentially along an optical axis from a first side to a second side. The first element group includes a reflective polarizing element, a first quarter-wave plate, a first lens, and a partially reflective element. The second element group includes a second lens, a second quarter-wave plate, a polarizer, and a display. The reflective polarizing element, the first quarter-wave plate, the first lens, and the partially reflective element are cemented sequentially from the first side to the second side. The second lens, the second quarter-wave plate, the polarizer, and the display are cemented sequentially from the first side to the second side. The first lens has a positive refractive power, with a first surface being a planar surface and a second surface being a convex surface. The second lens has a positive refractive power, with a first surface being a convex surface and a second surface being a planar surface. The second element group is movable between the first side and the second side along the optical axis to adjust a separation distance between the first element group and the second element group on the optical axis, so as to switch the optical system between a first state and a second state. The optical system is configured to satisfy the following relationships: 0.5<fz1/fz2<1.4 and 5.30≤(CT2+CTQ2+CTL)/ΔL≤7.71. fz1 represents a combined focal length of the reflective polarizing element, the first quarter-wave plate, and the first lens, fz2 represents a combined focal length of the second lens, the second quarter-wave plate, and the polarizer, CT2 represents a central thickness of the second lens on the optical axis, CTQ2 represents a central thickness of the second quarter-wave plate on the optical axis, CTL represent a central thickness of the polarizer on the optical axis, and ΔL represents a variation in the separation distance between the first element group and the second element group on the optical axis when the optical system is in the first state and the second state.

In an embodiment, the optical system is configured to satisfy the following relationship: 0.15 mm<(f2/f1)×Δf<0.35 mm, f2 represents an effective focal length of the second lens, f1 represents an effective focal length of the first lens, and Δf represents a variation in an effective focal length of the optical system between the first state and the second state.

In an embodiment, the optical system is configured to satisfy the following relationship: −2.15 mm<(R2/R3)×ΔL<−1.30 mm, R2 represents a radius of curvature of the second surface of the first lens, R3 represents a radius of curvature of the first surface of the second lens, and ΔL represents a variation in the separation distance between the first element group and the second element group on the optical axis when the optical system is in the first state and the second state.

In an embodiment, the optical system is configured to satisfy the following relationship: 5.66≤fm/T12m≤5.95, fm represents an effective focal length of the optical system in the first state, and T12m represents a distance between the second surface of the first lens and the first surface of the second lens on the optical axis when the optical system is in the first state.

In an embodiment, the optical system is configured to satisfy the following relationship: 2.21≤R3/TDn≤4.80, R3 represents a radius of curvature of the first surface of the second lens, and TDn represents a distance between the first surface of the first lens and the second surface of the second lens on the optical axis when the optical system is in the second state.

In an embodiment, the optical system is configured to satisfy the following relationship: 1.87≤fn/(CT1+CTR+CTQ1)≤2.50, fn represents an effective focal length of the optical system in the second state, CT1 represents a central thickness of the first lens on the optical axis, CTR represents a central thickness of the reflective polarizing element on the optical axis, and CTQ1 represents a central thickness of the first quarter-wave plate on the optical axis.

In an embodiment, the optical system is configured to satisfy the following relationship: 3.65≤T12n/Δf≤6.16, T12n represents a distance between the second surface of the first lens and the first surface of the second lens on the optical axis when the optical system is in the second state, and Δf represents a variation in an effective focal length of the optical system between the first state and the second state.

In an embodiment, the optical system is configured to satisfy the following relationship: 6.95<(TDm+TDn)/EPD<9.45, TDm represents a distance between the first surface of the first lens and the second surface of the second lens on the optical axis when the optical system is in the first state, TDn represents a distance between the first surface of the first lens and the second surface of the second lens on the optical axis when the optical system is in the second state, and EPD represents an entrance pupil diameter of the optical system.

In an embodiment, the optical system is configured to satisfy the following relationship: 1.93≤CT2/(T12m+T12n)≤2.82, CT2 represents the central thickness of the second lens on the optical axis, T12m represents a distance between the second surface of the first lens and the first surface of the second lens on the optical axis when the optical system is in the first state, and T12n represents a distance between the second surface of the first lens and the first surface of the second lens on the optical axis when the optical system is in the second state.

In an embodiment, the optical system is configured to satisfy the following relationship: 2.30≤(f1/N1)/TDm≤3.16, f1 represents an effective focal length of the first lens, N1 represents a refractive index of the first lens, and TDm represents a distance between the first surface of the first lens and the second surface of the second lens on the optical axis when the optical system is in the first state.

In an embodiment, the optical system is configured to satisfy the following relationship: 0.85≤(f2/V2)/ΔL≤1.63, f2 represents an effective focal length of the second lens, V2 represents a dispersion coefficient of the second lens, and ΔL represents a variation in the separation distance between the first element group and the second element group on the optical axis when the optical system is in the first state and the second state.

In an embodiment, the optical system is configured to satisfy the following relationship: 1.67 mm≤(fz1/CT1)×Δf≤3.58 mm, fz1 represents a combined focal length of the reflective polarizing element, the first quarter-wave plate, and the first lens, CT1 represents a central thickness of the first lens on the optical axis, and Δf represents a variation in an effective focal length of the optical system between the first state and the second state.

In an embodiment, the optical system is configured to satisfy the following relationship: 2.0 mm<(fz2/R3)×ΔL<3.2 mm, fz2 represents a combined focal length of the second lens, the second quarter-wave plate, and the polarizer, R3 represents a radius of curvature of the first surface of the second lens, and ΔL represents a variation in the separation distance between the first element group and the second element group on the optical axis when the optical system is in the first state and the second state.

In an embodiment, the optical system is configured to satisfy the following relationship: 2.20≤f2/(fm+fn)≤5.01, f2 represents an effective focal length of the second lens, fm represents an effective focal length of the optical system in the first state, and fn represents an effective focal length of the optical system in the second state.

In a second aspect of the present disclosure, an optical system is provided. The optical system includes a first element group and a second element group sequentially along an optical axis from a first side to a second side. The first element group includes a reflective polarizing element, a first quarter-wave plate, a first lens, and a partially reflective element. The second element group includes a second lens, a second quarter-wave plate, a polarizer, and a display. The reflective polarizing element, the first quarter-wave plate, the first lens, and the partially reflective element are cemented sequentially from the first side to the second side. The second lens, the second quarter-wave plate, the polarizer, and the display are cemented sequentially from the first side to the second side. The first lens has a positive refractive power, with a first surface being a planar surface and a second surface being a convex surface. The second lens has a positive refractive power, with a first surface being a convex surface and a second surface being a planar surface. The second element group is movable between the first side and the second side along the optical axis to adjust a separation distance between the first element group and the second element group on the optical axis, so as to switch the optical system between a first state and a second state. The optical system is configured to satisfy the following relationships: 0.5<fz1/fz2<1.4 and 0.85≤(f2/V2)/ΔL≤1.63, fz1 represents a combined focal length of the reflective polarizing element, the first quarter-wave plate, and the first lens, fz2 represents a combined focal length of the second lens, the second quarter-wave plate, and the polarizer, f2 represents an effective focal length of the second lens, V2 represents a dispersion coefficient of the second lens, and ΔL represents a variation in the separation distance between the first element group and the second element group on the optical axis when the optical system is in the first state and the second state.

In a third aspect of the present disclosure, an optical device is provided. The optical device includes the optical system as described in any one of the above embodiments.

The optical system according to the present disclosure may be a catadioptric optical system, and includes the first element group and the second element group. The second element group is movable along the optical axis between the first side and the second side, enabling the optical system to switch between the first state and the second state, which means that the optical system can achieve diopter adjustment functionality. Furthermore, the optical system according to the present disclosure satisfies: 0.5<fz1/fz2<1.4 and 5.30≤(CT2+CTQ2+CTL)/ΔL≤7.71. These constraints ensure proper distribution of the refractive power between the two lenses, allowing the diopter adjustment range of the optical system to be controlled within a proper range while maintaining processability and improving optical imaging performance. By incorporating the diopter adjustment functionality, the optical system can adopt a smaller exit pupil distance, which further contributes to reducing a length of the optical system.

### BRIEF DESCRIPTION OF THE DRAWINGS

From the detailed description of the non-limiting embodiments with reference to the accompanying drawings, other features, purposes, and advantages of the present disclosure will become more apparent.

FIG. 1 illustrates a schematic structural diagram of an optical system in a +2D state according to Embodiment 1 of the present disclosure.

FIG. 2 illustrates a modulating transfer function curve of the optical system in the +2D state according to Embodiment 1 of the present disclosure.

FIG. 3 illustrates a schematic structural diagram of the optical system in a −5D state according to Embodiment 1 of the present disclosure.

FIG. 4 illustrates a modulating transfer function curve of the optical system in the −5D state according to Embodiment 1 of the present disclosure.

FIG. 5 illustrates a schematic structural diagram of an optical system in the +2D state according to Embodiment 2 of the present disclosure.

FIG. 6 illustrates a modulating transfer function curve of the optical system in the +2D state according to Embodiment 2 of the present disclosure.

FIG. 7 illustrates a schematic structural diagram of the optical system in the −5D state according to Embodiment 2 of the present disclosure.

FIG. 8 illustrates a modulating transfer function curve of the optical system in the −5D state according to Embodiment 2 of the present disclosure.

FIG. 9 illustrates a schematic structural diagram of an optical system in the +2D state according to Embodiment 3 of the present disclosure.

FIG. 10 illustrates a modulating transfer function curve of the optical system in the +2D state according to Embodiment 3 of the present disclosure.

FIG. 11 illustrates a schematic structural diagram of the optical system in the −5D state according to Embodiment 3 of the present disclosure.

FIG. 12 illustrates a modulating transfer function curve of the optical system in the −5D state according to Embodiment 3 of the present disclosure.

FIG. 13 illustrates a schematic structural diagram of an optical system in the +2D state according to Embodiment 4 of the present disclosure.

FIG. 14 illustrates a modulating transfer function curve of the optical system in the +2D state according to Embodiment 4 of the present disclosure.

FIG. 15 illustrates a schematic structural diagram of the optical system in the −5D state according to Embodiment 4 of the present disclosure.

FIG. 16 illustrates a modulating transfer function curve of the optical system in the −5D state according to Embodiment 4 of the present disclosure.

FIG. 17 illustrates a schematic structural diagram of an optical system in the +2D state according to Embodiment 5 of the present disclosure.

FIG. 18 illustrates a modulating transfer function curve of the optical system in the +2D state according to Embodiment 5 of the present disclosure.

FIG. 19 illustrates a schematic structural diagram of the optical system in the −5D state according to Embodiment 5 of the present disclosure.

FIG. 20 shows a modulating transfer function curve of the optical system in the −5D state according to Embodiment 5 of the present disclosure.

### DETAILED DESCRIPTION

For a better understanding of the present disclosure, various aspects of the present disclosure will be described in greater detail with reference to the accompanying drawings. It should be understood that these detailed descriptions are merely descriptive exemplary embodiments of the present disclosure and are not intended to limit the scope of the present disclosure in any way. The same reference numerals refer to the same elements throughout the specification. The expression “and/or” includes any and all combinations of one or more of associated listed items.

It should be noted that throughout this specification, the expressions of first, second, etc. are used merely to distinguish one feature from another and do not represent any limitation on the feature. Thus, the first lens discussed below may also be referred to as the second lens or the third lens without departing from the teachings of the present disclosure.

In the accompanying drawings, a thickness, a size, and a shape of the lens have been slightly exaggerated for ease of illustration. Specifically, a spherical or aspherical shape, shown in the accompanying drawings, is illustrated by way of example. That is, the spherical or aspherical shape is not limited to that shown in the accompanying drawings. The drawings are examples only and are not drawn to scale strictly.

Herein, a paraxial area refers to an area near an optical axis. When a lens surface is a convex surface and a position of the convex surface is not defined, it represents that the lens surface is a convex surface at least at the paraxial area. When the lens surface is a concave surface and a position of the concave surface is not defined, it represents that the lens surface is a concave surface at least at the paraxial area. The determination for the surface shape at the paraxial area may be based on the method commonly used in the art. For example, it is determined whether the surface is concave or convex according to whether a R value (R refers to a radius of curvature at the paraxial area) is positive or negative. For a first surface, it is determined that the first surface is a convex surface when the R value is positive, and it is determined that the first surface is a concave surface when the R value is negative. For a second surface, it is determined that the second surface is a concave surface when the R value is positive, and it is determined that the second surface is a convex surface when the R value is negative.

It should also be understood that the terms “comprises”, “comprising”, “has”, “includes”, and/or “including” when used in this specification, indicate the presence of stated features, elements, and/or components, but do not preclude the presence or addition of one or more other features, elements, components, and/or combinations thereof. Furthermore, when a statement such as “at least one of . . . ” appears before a list of listed features, it modifies the entire listed features, rather than an individual element in the list. Furthermore, when describing embodiments of the present disclosure, the use of “may” means “one or more embodiments of the present disclosure”. In addition, the term “exemplary” is intended to refer to an example, or illustration.

All terms (including technical and scientific terms) used herein have the same meaning as commonly understood by those skilled in the art to which the present disclosure belongs unless otherwise defined. It should also be understood that terms (for example, terms defined in commonly used dictionaries) should be interpreted as having a meaning that is consistent with their meaning in the context of the relevant art and will not be interpreted in an idealized or overly formalized sense unless expressly defined herein.

It should be noted that the embodiments of the present disclosure and the features of the embodiments may be combined with each other without conflict. The present disclosure will be described in detail below with reference to the accompanying drawings in conjunction with embodiments.

An optical system according to an exemplary embodiment of the present disclosure includes a first element group and a second element group sequentially from a first side to a second side along an optical axis. The first element group includes a reflective polarizing element, a first quarter-wave plate, a first lens, and a partially reflective element. The second element group includes a second lens, a second quarter-wave plate, a polarizer, and a display. The display may be configured to provide image or image-carrying light.

In an exemplary embodiment, the reflective polarizing element, the first quarter-wave plate, the first lens, and the partial reflective element are cemented sequentially from the first side to the second side. That is, the second surface of the reflective polarizing element may be attached to the first surface of the first quarter-wave plate, and the second surface of the first quarter-wave plate may be attached to the first surface of the first lens. The partially reflective element may be attached to the second surface of the first lens.

In an exemplary embodiment, the second lens, the second quarter-wave plate, the polarizer, and the display are cemented sequentially from the first side to the second side. That is, the second surface of the second lens may be attached to the first surface of the second quarter-wave plate, and the second surface of the second quarter-wave plate may be attached to the first surface of the polarizer.

When an object distance changes, the optical system may be switched between a first state and a second state by adjusting a separation distance between the first element group and the second element group on the optical axis, thereby realizing the diopter adjustment functionality of the optical system. For example, the first state may be a +2D state, the second state may be a −5D state, and D represents a diopter. More specifically, the diopter adjustment functionality of the optical system may be realized by moving the second element group between the first side and the second side along the optical axis, either toward or away from the first element group. When the second element group is away from the first element group, the optical system is in the first state (+2D state). When the second element group is close to the first element group, the optical system is in the second state (−5D state).

Those skilled in the art should understand that the reflective polarizing element may reflect first polarized light in a certain polarization direction while transmitting second polarized light whose direction is orthogonal to the polarization direction. The quarter-wave plate may be configured to change a state of the second polarized light. The required optical path may be folded by combining light reflection and refraction of the reflective polarizing element and the quarter-wave plate, thereby effectively shortening the length of the optical system.

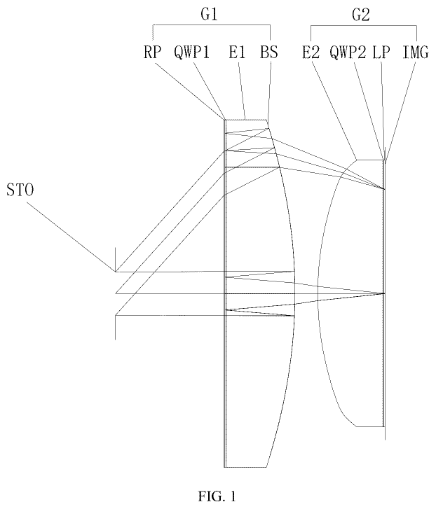

In an exemplary embodiment, the optical system according to the present disclosure may be applied to, for example, a VR device. The first side may be, for example, a human eye side, and the second side may be, for example, a display side (or a screen side). A surface of each lens most proximate to the human eye side may be referred to as a human eye-proximal surface of the lens, and a surface of each lens most proximate to the display may be referred to as a display-proximal surface (or a screen-proximal surface) of the lens. Referring to FIG. 1, the optical system includes a first element group G1 and a second element group G2 sequentially from the human eye side to the screen side along an optical axis. The first element group G1 includes a reflective polarizing element RP, a first quarter-wave plate QWP1, a first lens E1, and a partially reflective element BS. The second element group G2 includes a second lens E2, a second quarter-wave plate QWP2, a polarizer LP, and a display IMG. The reflective polarizing element RP may be attached to the human eye-proximal surface of the first quarter-wave plate QWP1, and the first quarter-wave plate QWP1 may be attached to the human eye-proximal surface of the first lens E1. The partially reflective element BS may have semi-transmissive and semi-reflective functionality and be attached to the screen-proximal surface of the first lens E1. The second quarter-wave plate QWP2 may be attached to the screen-proximal surface of the second lens E2, the polarizer LP may be attached to the screen-proximal surface of the second quarter-wave plate QWP2, and the display IMG may be attached to the screen-proximal surface of the polarizer LP.

Referring to FIG. 1, the optical system according to the present disclosure may further include a diaphragm STO disposed at the human eye side. The eyes of the user may view an image projected by the display IMG at a position of the diaphragm STO. Specifically, FIG. 1 further shows a schematic diagram of light path reversal of the optical system according to the present disclosure. Light emitted by the display IMG may sequentially pass through the polarizer LP, the second quarter-wave plate QWP2, the second lens E2, the first lens E1, and the first quarter-wave plate QWP1 to reach the reflective polarizing element RP. Then the light may be reflected at the reflective polarizing element RP and pass again through the first quarter-wave plate QWP1 and the first lens E1. The light beam may be reflected again at the partially reflective element BS on the screen-proximal surface of the first lens E1, and sequentially pass through the first lens E1, the first quarter-wave plate QWP1, and the reflective polarizing element RP, then pass through the diaphragm STO, and finally exit towards the human eye side.

In an exemplary embodiment, the first lens has a positive refractive power, with a first surface being a planar surface and a second surface being a convex surface.

In an exemplary embodiment, the second lens has a positive refractive power, with a first side being a convex surface and a second side being a planar surface.

In an exemplary embodiment, the optical system of the present disclosure satisfies the following relationship: 0.5<fz1/fz2<1.4, fz1 represents a combined focal length of the reflective polarizing element, the first quarter-wave plate, and the first lens, and fz2 represents a combined focal length of the second lens, the second quarter-wave plate, and the polarizer. Satisfying the following relationship: 0.5<fz1/fz2<1.4 can facilitate properly distributing refractive power between the first lens and the second lens, so that a diopter adjustment range of the optical system is controlled within a proper range, and optical imaging performance is improved. By incorporating the diopter adjustment functionality, the optical system can adopt a smaller exit pupil distance, which further contributes to reducing the length of the optical system.

In an exemplary embodiment, the optical system of the present disclosure satisfies the following relationship: 5.30≤(CT2+CTQ2+CTL)/ΔL≤7.71, CT2 represents a central thickness of the second lens on the optical axis, CTQ2 represents a central thickness of the second quarter-wave plate on the optical axis, CTL represents a central thickness of the polarizer on the optical axis, and ΔL represents a variation in the separation distance between the first element group and the second element group on the optical axis when the optical system is in the first state and the second state. Satisfying the following relationship: 5.30≤(CT2+CTQ2+CTL)/ΔL≤7.71 can facilitate controlling the overall length of the second element group and controlling the moving range of the second element group within a proper range, while ensuring the processability of the second element group and improving the optical imaging performance.

In an exemplary embodiment, the optical system of the present disclosure may satisfy the following relationship: 0.15 mm<(f2/f1)×Δf<0.35 mm, f2 represents an effective focal length of the second lens, f1 represents an effective focal length of the first lens, and Δf represents a variation in an effective focal length of the optical system between the first state and the second state. Satisfying the following relationship: 0.15 mm<(f2/f1)×Δf<0.35 mm enables the optical system to achieve the diopter adjustment functionality when switching from the first state to the second state or from the second state to the first state. For example, the optical system can achieve the diopter adjustment functionality from the +2D state to the −5D state.

In an exemplary embodiment, the optical system of the present disclosure may satisfy the following relationship: −2.15 mm<(R2/R3)×ΔL<−1.30 mm, R2 represents a radius of curvature of the second surface of the first lens, R3 represents a radius of curvature of the first surface of the second lens, and ΔL represents a variation in the separation distance between the first element group and the second element group on the optical axis when the optical system is in the first state and the second state. Satisfying the following relationship: −2.15 mm<(R2/R3)×ΔL<−1.30 mm ensures the processability of the first lens and the second lens, while constraining the moving range of the second element group within a proper range, thereby improving the imaging quality of the system.

In an exemplary embodiment, the optical system of the present disclosure may satisfy the following relationship: 5.66≤fm/T12m≤5.95, fm represents an effective focal length of the optical system in the first state, and T12m represents a distance between the second surface of the first lens and the first surface of the second lens on the optical axis when the optical system is in the first state. Satisfying the following relationship: 5.66≤fm/T12m≤5.95 can facilitate ensuring a space in which the second element group may move during the diopter adjustment of the system.

In an exemplary embodiment, the optical system of the present disclosure may satisfy the following relationship: 2.21≤R3/TDn≤4.80, R3 represents a radius of curvature of the first surface of the second lens, and TDn represents a distance between the first surface of the first lens and the second surface of the second lens on the optical axis when the optical system is in the second state. Satisfying the following relationship: 2.21≤R3/TDn≤4.80 can improve imaging clarity and accuracy while reducing optical distortion. Meanwhile, the focus change of the system in different states is reduced, and thus the focus adjustment stability and the consistency of the system are ensured.

In an exemplary embodiment, the optical system of the present disclosure may satisfy the following relationship: 1.87≤fn/(CT1+CTR+CTQ1)≤2.50, fn represents an effective focal length of the optical system in the second state, CT1 represents a central thickness of the first lens on the optical axis, CTR represents a central thickness of the reflective polarizing element on the optical axis, and CTQ1 represents a central thickness of the first quarter-wave plate on the optical axis. Satisfying the following relationship: 1.87≤fn/(CT1+CTR+CTQ1)≤2.50 can ensure that the optical system can achieve −5D diopter functionality in the second state by properly designing the relationship between the effective focal length of the optical system in the second state and the sum of the thicknesses of the first lens, the reflective polarizing element, and the first quarter-wave plate in the first element group.

In an exemplary embodiment, the optical system of the present disclosure may satisfy the following relationship: 3.65≤T12n/Δf≤6.16, T12n represents a distance between the second surface of the first lens and the first surface of the second lens on the optical axis when the optical system is in the second state, and Δf represents a variation in an effective focal length of the optical system between the first state and the second state. Satisfying the following relationship: 3.65≤T12n/Δf≤6.16 can ensure that the first lens and the second lens do not interfere with each other in the second state (−5D state).

In an exemplary embodiment, the optical system of the present disclosure may satisfy the following relationship: 6.95<(TDm+TDn)/EPD<9.45, TDm represents a distance between the first surface of the first lens and the second surface of the second lens on the optical axis when the optical system is in the first state, TDn represents a distance between the first surface of the first lens and the second surface of the second lens on the optical axis when the optical system is in the second state, and EPD represents an entrance pupil diameter of the optical system. Satisfying the following relationship: 6.95<(TDm+TDn)/EPD<9.45 can facilitate controlling the overall length of the optical system, resulting in a thinner and lighter product.

In an exemplary embodiment, the optical system of the present disclosure may satisfy the following relationship: 1.93≤CT2/(T12m+T12n)≤2.82, CT2 represents the central thickness of the second lens on the optical axis, T12m represents a distance between the second surface of the first lens and the first surface of the second lens on the optical axis when the optical system is in the first state, and T12n represents a distance between the second surface of the first lens and the first surface of the second lens on the optical axis when the optical system is in the second state. Satisfying the following relationship: 1.93≤CT2/(T12m+T12n)≤2.82 can constrain the separation distance between the first lens and the second lens, thereby reducing the overall length of the optical system and resulting in a thinner and lighter product.

In an exemplary embodiment, the optical system of the present disclosure may satisfy the following relationship: 2.30≤(f1/N1)/TDm≤3.16, f1 represents an effective focal length of the first lens, N1 represents a refractive index of the first lens, and TDm represents a distance between the first surface of the first lens and the second surface of the second lens on the optical axis when the optical system is in the first state. Satisfying the following relationship: 2.30≤(f1/N1)/TDm≤3.16 can facilitate improving the imaging performance of the system while controlling the material cost of the first lens.

In an exemplary embodiment, the optical system of the present disclosure may satisfy the following relationship: 0.85≤(f2/V2)/ΔL≤1.63, f2 represents an effective focal length of the second lens, V2 represents a dispersion coefficient of the second lens, and ΔL represents a variation in the separation distance between the first element group and the second element group on the optical axis when the optical system is in the first state and the second state. Satisfying the following relationship: 0.85≤(f2/V2)/ΔL≤1.63 can facilitate reducing chromatic aberration and improving imaging performance of the system while controlling the material cost of the second lens.

In an exemplary embodiment, the optical system of the present disclosure may satisfy the following relationship: 1.67 mm≤(fz1/CT1)×Δf≤3.58 mm, fz1 represents the combined focal length of the reflective polarizing element, the first quarter-wave plate, and the first lens, CT1 represents a central thickness of the first lens on the optical axis, and Δf represents a variation in an effective focal length of the optical system between the first state and the second state. Satisfying the following relationship: 1.67 mm≤(fz1/CT1)×Δf≤3.58 mm can facilitate reducing the overall length of the system by reducing the thickness of the first lens while ensuring the processability of the lens.

In an exemplary embodiment, the optical system of the present disclosure may satisfy the following relationship: 2.0 mm<(fz2/R3)×ΔL<3.2 mm, fz2 represents the combined focal length of the second lens, the second quarter-wave plate, and the polarizer, R3 represents a radius of curvature of the first surface of the second lens, and ΔL represents a variation in the separation distance between the first element group and the second element group on the optical axis when the optical system is in the first state and the second state. Satisfying the following relationship: 2.0 mm<(fz2/R3)×ΔL<3.2 mm can enhance light convergence, enabling the system to satisfy imaging requirements while reducing the sensitivity tolerance of the lens.

In an exemplary embodiment, the optical system of the present disclosure may satisfy the following relationship: 2.20≤f2/(fm+fn)≤5.01, f2 represents an effective focal length of the second lens, fm represents an effective focal length of the optical system in the first state, and fn represents an effective focal length of the optical system in the second state. Satisfying the following relationship: 2.20≤f2/(fm+fn)≤5.01 can enable the optical system to satisfy different diopters requirements in the first state (+2D state) and the second state (−5D state).

In an exemplary embodiment, the optical system of the present disclosure may include at least one diaphragm. The diaphragm can constrain the light path and control the light intensity. The diaphragm may be disposed in an appropriate position of the optical system. For example, the diaphragm may be located at the first side of the first lens.

In an exemplary embodiment, the effective focal length fm of the optical system in the first state may be, for example, in a range of 12.49 mm to 15.94 mm, and the effective focal length fn of the optical system in the second state may be, for example, in a range of 12.26 mm to 15.77 mm. The combined focal length fz1 of the reflective polarizing element, the first quarter-wave plate, and the first lens (i.e., the effective focal length f1 of the first lens) may be, for example, in a range of 73.59 mm to 86.41 mm, and the combined focal length fz2 of the second lens, the second quarter-wave plate, and the polarizer (i.e., the effective focal length f2 of the second lens) may be, for example, in a range of 54.40 mm to 158.73 mm.

According to some embodiments of the present disclosure, the optical system of the present disclosure may be a small-volume optical system with high-definition imaging quality. In practical applications, the optical system according to exemplary embodiments of the present disclosure may be applicable to a VR device. Through proper design of the structural arrangement of the lens, the reflective polarizing element, the quarter-wave plate, the partially reflective element, and the display, the volume and weight of the system may be reduced while the diopter adjustment functionality is ensured, and the light energy utilization efficiency may be improved, thus providing a more comfortable and high-quality virtual reality experience for users.

In an embodiment of the present disclosure, at least one of the mirror surfaces of the lenses is an aspherical mirror surface. An aspherical lens is characterized by a continuous change in curvature from the center to the periphery of the lens. Unlike spherical lenses having a constant curvature from the center to the periphery, the aspherical lens may have better radius of curvature characteristics, and have advantages of reducing distortion aberration and astigmatism aberration. By using the aspherical lens, aberrations occurring during imaging can be eliminated as much as possible, thereby improving imaging quality. Alternatively, each of the second surface of the first lens and the first surface of the second lens is the aspherical mirror surface.

Specific embodiments of the optical system applicable to the above embodiments may be further described below with reference to the accompanying drawings. Specifically, an example is taken where the optical system is applied to, for example, a VR device, with the first side being the human eye side and the second side being the screen side.

### Embodiment 1

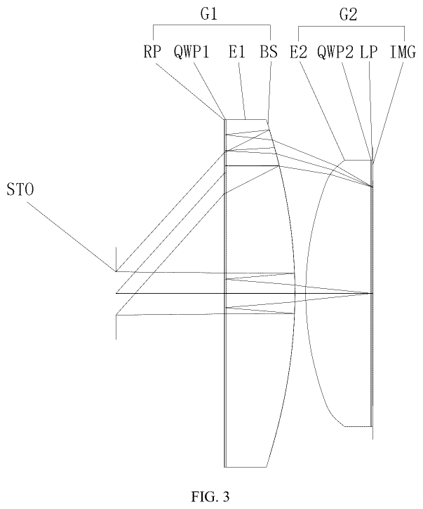

An optical system according to Embodiment 1 of the present disclosure is described below with reference to FIG. 1 to FIG. 4. FIG. 1 is a schematic structural diagram of the optical system in the +2D state according to Embodiment 1 of the present disclosure. FIG. 3 is a schematic structural diagram of the optical system in the −5D state according to Embodiment 1 of the present disclosure.

Referring to FIG. 1 and FIG. 3, the optical system of Embodiment 1 includes a diaphragm STO, a first element group G1, and a second element group G2. The first element group G1 includes a reflective polarizing element RP, a first quarter-wave plate QWP1, a first lens E1, and a partially reflective element BS, and the second element group G2 includes a second lens E2, a second quarter-wave plate QWP2, a polarizer LP, and a display IMG. The reflective polarizing element RP may be attached to the human eye-proximal surface of the first quarter-wave plate QWP1, and the first quarter-wave plate QWP1 may be attached to the human eye-proximal surface of the first lens E1. The partially reflective element BS may have semi-transmissive and semi-reflective functionality and be attached to the screen-proximal surface of the first lens E1. The second quarter-wave plate QWP2 may be attached to the screen-proximal surface of the second lens E2, the polarizer LP may be attached to the screen-proximal surface of the second quarter-wave plate QWP2, and the display IMG may be attached to the screen-proximal surface of the polarizer LP.

The first lens E1 has a positive refractive power, with the human eye-proximal surface being a planar surface and the screen-proximal surface being a convex surface. The second lens E2 has a positive refractive power, with the human eye-proximal surface being a convex surface and the screen-proximal surface being a planar surface.

In this embodiment, the light emitted by the display IMG may sequentially pass through the polarizer LP, the second quarter-wave plate QWP2, the second lens E2, the first lens E1, and the first quarter-wave plate QWP1 to reach the reflective polarizing element RP. A light beam may be then reflected at the reflective polarizing element RP and pass again through the first quarter-wave plate QWP1 and the first lens E1. The light beam may be reflected again at the partially reflective element BS on the screen-proximal surface of the first lens E1, and sequentially pass through the first lens E1, the first quarter-wave plate QWP1, and the reflective polarizing element RP, then pass through the diaphragm STO and finally exit towards the human eye side.

Table 1 shows basic parameters of the optical system of Embodiment 1, each of the units of the radius of curvature and the thickness/distance is millimeter (mm). Table 1 only lists the correspondence between surface numbers of some surfaces and some elements. Due to attached and shared surface issues between adjacent elements, it is not feasible to label all elements at positions with shared surfaces in Table 1.

TABLE 1

| | | Surface | Radius of | Thickness/ | Refractive | Abbe | Refractive/ | Conical |
|---|---|---|---|---|---|---|---|---|
| No. | Element name | type | curvature | distance | index | Number | reflective | coefficient |
| 0 | | Spherical | Infinite | D1 | | | Refractive | |
| | | surface | | | | | | |
| 1 | Diaphragm | Spherical | Infinite | 10.0000 | | | Refractive | |
| | (STO) | surface | | | | | | |
| 2 | Reflective | Spherical | Infinite | 0.1000 | 1.517 | 64.17 | Refractive | |
| | polarizing | surface | | | | | | |
| | element (RP) | | | | | | | |
| 3 | First quarter- | Spherical | Infinite | 0.1000 | 1.517 | 64.17 | Refractive | |
| | wave plate | surface | | | | | | |
| | (QWP1) | | | | | | | |
| 4 | First lens (E1) | Spherical | Infinite | 6.3697 | 1.639 | 23.52 | Refractive | |
| | | surface | | | | | | |
| 5 | Partially | Aspherical | −47.9562 | −6.3697 | 1.639 | 23.52 | Reflective | 2.7419 |
| | reflective | surface | | | | | | |
| | element (BS) | | | | | | | |
| 6 | | Spherical | Infinite | −0.1000 | 1.517 | 64.17 | Refractive | |
| | | surface | | | | | | |
| 7 | Reflective | Spherical | Infinite | 0.1000 | 1.517 | 64.17 | Reflective | |
| | polarizing | surface | | | | | | |
| | element (RP) | | | | | | | |
| 8 | First lens (E1) | Spherical | Infinite | 6.3697 | 1.639 | 23.52 | Refractive | |
| | | surface | | | | | | |
| 9 | | Aspherical | −47.9562 | D2 | | | Refractive | 2.7419 |
| | | surface | | | | | | |
| 10 | Second Lens | Aspherical | 29.5910 | 6.0000 | 1.544 | 55.92 | Refractive | 4.5442 |
| | (E2) | surface | | | | | | |
| 11 | Second | Spherical | Infinite | 0.1000 | 1.517 | 64.17 | Refractive | |
| | quarter-wave | surface | | | | | | |
| | plate (QWP2) | | | | | | | |
| 12 | Polarizer (LP) | Spherical | Infinite | 0.1000 | 1.517 | 64.17 | Refractive | |
| | | surface | | | | | | |
| 13 | | Spherical | Infinite | 0.0000 | | | Refractive | |
| | | surface | | | | | | |
| 14 | Display (IMG) | Spherical | Infinite | 0.0000 | | | Refractive | |
| | | surface | | | | | | |

In this embodiment, when the object distance D1 changes, the second element group G2 of the optical system may move along the optical axis to perform the diopter adjustment functionality. Table 2 shows the air separation D2 between the first lens and the second lens on the optical axis of the optical system of Embodiment 1 at different object distances D1. When the object distance D1 is equal to 500 mm, the optical system is in the first state (+2D state). When the object distance D1 is equal to −200 mm, the optical system is in the second state (−5D state). Each of the units in Table 2 is millimeter (mm).

TABLE 2

| | D1 | D2 |
|---|---|---|
| +2D state | 500.0000 | 2.1069 |
| −5D state | −200.0000 | 1.0000 |

In Embodiment 1, each of the screen-proximal surface of the first lens E1 and the human eye-proximal surface of the second lens E2 may be the aspherical surface, and the surface types of the aspherical lenses may be defined by, but not limited to, the following aspherical surface formula:

$$x = \frac{{ch}^{2}}{1 + \sqrt{1 - ( k + 1 ) {c}^{2} {h}^{2}}} + \sum {Aih}^{\text{?}} \qquad ( 1 )$$

$$\text{?} \text{indicates text missing or illegible when filed}$$

x represents sag—an axis-component of the surface from the aspherical vertex, when the surface is at height h from the optical axis; c represents a paraxial curvature of the aspherical surface, c=1/R (i.e., the paraxial curvature c represents a reciprocal of the radius of curvature R in above Table 1); k represents a conic coefficient; and Ai represents a correction coefficient for an i-th order of the aspherical surface. Table 3 below shows the high-order coefficients A4, A6, A8, A10, A12, A14, A16, and A18 applicable to the aspherical mirror surfaces in Embodiment 1.

TABLE 3

| Element | | | | | | | | | |
|---|---|---|---|---|---|---|---|---|---|
| name | Surface | A4 | A6 | A8 | A10 | A12 | A14 | A16 | A18 |
| First | Screen- | 4.3568E−06 | 3.8240E−09 | 1.3745E−11 | 2.7647E−14 | −7.3707E−17 | 0.0000E+00 | 0.0000E+00 | 0.0000E+00 |
| lens | proximal | | | | | | | | |
| | surface | | | | | | | | |
| Second | Human eye- | 1.6544E−05 | −8.1139E−07 | 3.2323E−09 | 0.0000E+00 | 0.0000E+00 | 0.0000E+00 | 0.0000E+00 | 0.0000E+00 |
| lens | proximal | | | | | | | | |
| | surface | | | | | | | | |

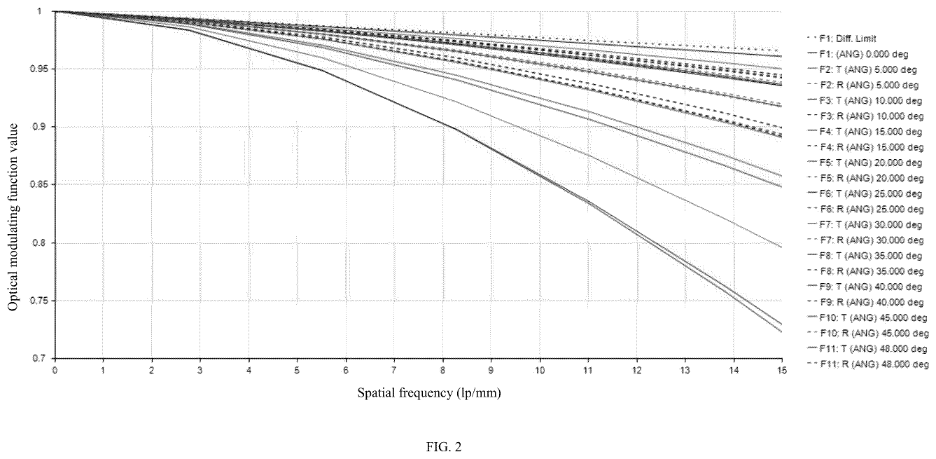

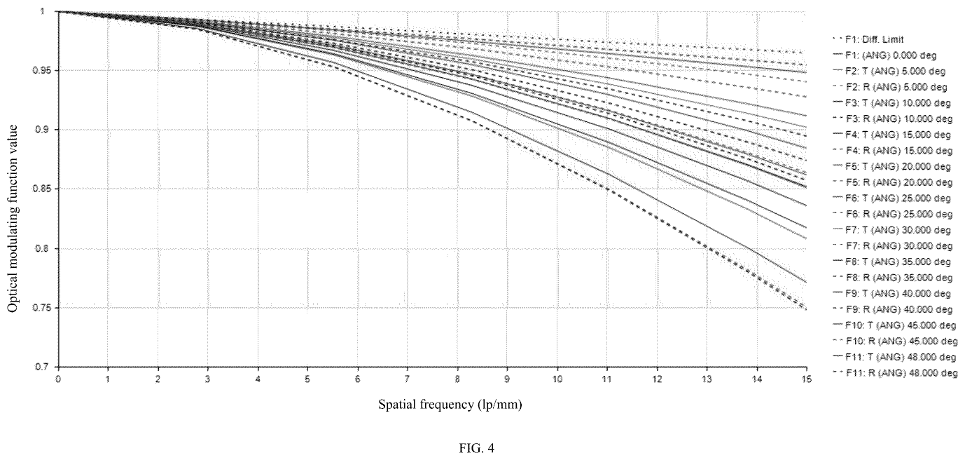

FIG. 2 is a modulating transfer function curve of the optical system of Embodiment 1 in the +2D state, and FIG. 4 is a modulating transfer function curve of the optical system of Embodiment 1 in the −5D state. It can be seen from FIG. 2 and FIG. 4 that the optical system in Embodiment 1 can achieve excellent imaging quality across different diopter states.

### Embodiment 2

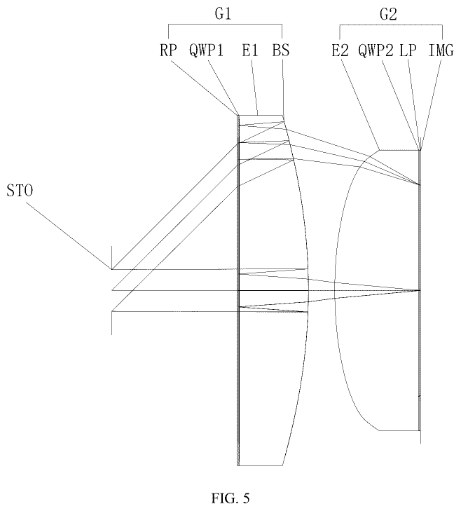

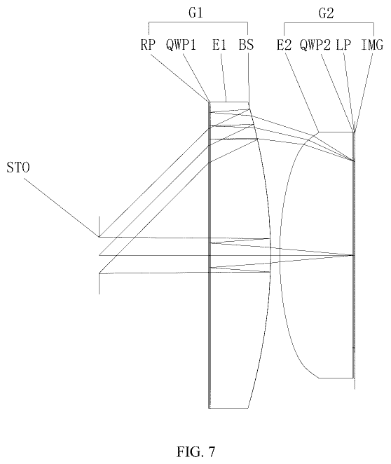

An optical system according to Embodiment 2 of the present disclosure is described below with reference to FIG. 5 to FIG. 8. FIG. 5 is a schematic structural diagram of the optical system in the +2D state according to Embodiment 2 of the present disclosure. FIG. 7 is a schematic structural diagram of the optical system in the −5D state according to Embodiment 2 of the present disclosure. In this embodiment and following embodiments, some descriptions similar to those in Embodiment 1 will be omitted for brevity.

Referring to FIG. 5 and FIG. 7, the optical system of Embodiment 2 includes a diaphragm STO, a first element group G1, and a second element group G2. The first element group G1 includes a reflective polarizing element RP, a first quarter-wave plate QWP1, a first lens E1, and a partially reflective element BS, and the second element group G2 includes a second lens E2, a second quarter-wave plate QWP2, a polarizer LP, and a display IMG. The reflective polarizing element RP may be attached to the human eye-proximal surface of the first quarter-wave plate QWP1, and the first quarter-wave plate QWP1 may be attached to the human eye-proximal surface of the first lens E1. The partially reflective element BS may have semi-transmissive and semi-reflective functionality and be attached to the screen-proximal surface of the first lens E1. The second quarter-wave plate QWP2 may be attached to the screen-proximal surface of the second lens E2, the polarizer LP may be attached to the screen-proximal surface of the second quarter-wave plate QWP2, and the display IMG may be attached to the screen-proximal surface of the polarizer LP.

The first lens E1 has a positive refractive power, with the human eye-proximal surface being a planar surface and the screen-proximal surface being a convex surface. The second lens E2 has a positive refractive power, with the human eye-proximal surface being a convex surface and the screen-proximal surface being a planar surface.

In this embodiment, the light emitted by the display IMG may sequentially pass through the polarizer LP, the second quarter-wave plate QWP2, the second lens E2, the first lens E1, and the first quarter-wave plate QWP1 to reach the reflective polarizing element RP. A light beam may be then reflected at the reflective polarizing element RP and pass again through the first quarter-wave plate QWP1 and the first lens E1. The light beam may be reflected again at the partially reflective element BS on the screen-proximal surface of the first lens E1, and sequentially pass through the first lens E1, the first quarter-wave plate QWP1, and the reflective polarizing element RP, then pass through the diaphragm STO and finally exit towards the human eye side.

Table 4 shows basic parameters of the optical system of Embodiment 2, and each of the units of the radius of curvature and the thickness/distance is millimeter (mm).

TABLE 4

| | | Surface | Radius of | Thickness/ | Refractive | Abbe | Refractive/ | Conical |
|---|---|---|---|---|---|---|---|---|
| No. | Element name | type | curvature | distance | index | number | reflective | coefficient |
| 0 | | Spherical | Infinite | D1 | | | Refractive | |
| | | surface | | | | | | |
| 1 | Diaphragm | Spherical | Infinite | 12.0000 | | | Refractive | |
| | (STO) | surface | | | | | | |
| 2 | Reflective | Spherical | Infinite | 0.1000 | 1.517 | 64.17 | Refractive | |
| | polarizing | surface | | | | | | |
| | element (RP) | | | | | | | |
| 3 | First quarter- | Spherical | Infinite | 0.1000 | 1.517 | 64.17 | Refractive | |
| | wave plate | surface | | | | | | |
| | (QWP1) | | | | | | | |
| 4 | First lens (E1) | Spherical | Infinite | 6.6172 | 1.639 | 23.52 | Refractive | |
| | | surface | | | | | | |
| 5 | Partially | Aspherical | −55.2294 | −6.6172 | 1.639 | 23.52 | Reflective | 2.8059 |
| | reflective | surface | | | | | | |
| | element (BS) | | | | | | | |
| 6 | | Spherical | Infinite | −0.1000 | 1.517 | 64.17 | Refractive | |
| | | surface | | | | | | |
| 7 | Reflective | Spherical | Infinite | 0.1000 | 1.517 | 64.17 | Reflective | |
| | polarizing | surface | | | | | | |
| | element (RP) | | | | | | | |
| 8 | First lens (E1) | Spherical | Infinite | 6.6172 | 1.639 | 23.52 | Refractive | |
| | | surface | | | | | | |
| 9 | | Aspherical | −55.2294 | D2 | | | Refractive | 2.8059 |
| | | surface | | | | | | |
| 10 | Second Lens | Aspherical | 39.2193 | 8.0000 | 1.544 | 55.92 | Refractive | 7.2329 |
| | (E2) | surface | | | | | | |
| 11 | Second quarter- | Spherical | Infinite | 0.1000 | 1.517 | 64.17 | Refractive | |
| | wave plate | surface | | | | | | |
| | (QWP2) | | | | | | | |
| 12 | Polarizer (LP) | Spherical | Infinite | 0.1000 | 1.517 | 64.17 | Refractive | |
| | | surface | | | | | | |
| 13 | | Spherical | Infinite | 0.0000 | | | Refractive | |
| | | surface | | | | | | |
| 14 | Display (IMG) | Spherical | Infinite | 0.0000 | | | Refractive | |
| | | surface | | | | | | |

In this embodiment, when the object distance D1 changes, the second element group G2 of the optical system may move along the optical axis to perform the diopter adjustment functionality. Table 5 shows the air separation D2 between the first lens and the second lens on the optical axis of the optical system of Embodiment 2 at different object distances D1. When the object distance D1 is equal to 500 mm, the optical system is in the first state (+2D state). When the object distance D1 is equal to −200 mm, the optical system is in the second state (−5D state). Each of the units in Table 5 is millimeter (mm).

TABLE 5

| | D1 | D2 |
|---|---|---|
| +2D state | 500.0000 | 2.5181 |
| −5D state | −200.0000 | 1.0000 |

Table 6 shows the high-order coefficients applicable to the aspherical mirror surfaces in Embodiment 2, and the surface types of the aspherical lenses may be defined by the formula (1) given in the above Embodiment 1.

TABLE 6

| Element | | | | | | | | | |
|---|---|---|---|---|---|---|---|---|---|
| name | Surface | A4 | A6 | A8 | A10 | A12 | A14 | A16 | A18 |
| First | surface | 3.2268E−06 | 1.4104E−09 | 1.7916E−11 | −2.2793E−14 | −3.9628E−18 | 0.0000E+00 | 0.0000E+00 | 0.0000E+00 |
| lens | Screen- | | | | | | | | |
| | proximal | | | | | | | | |
| Second | Human eye- | 1.0535E−05 | −2.6024E−07 | 1.3695E−09 | 0.0000E+00 | 0.0000E+00 | 0.0000E+00 | 0.0000E+00 | 0.0000E+00 |
| lens | proximal | | | | | | | | |
| | surface | | | | | | | | |

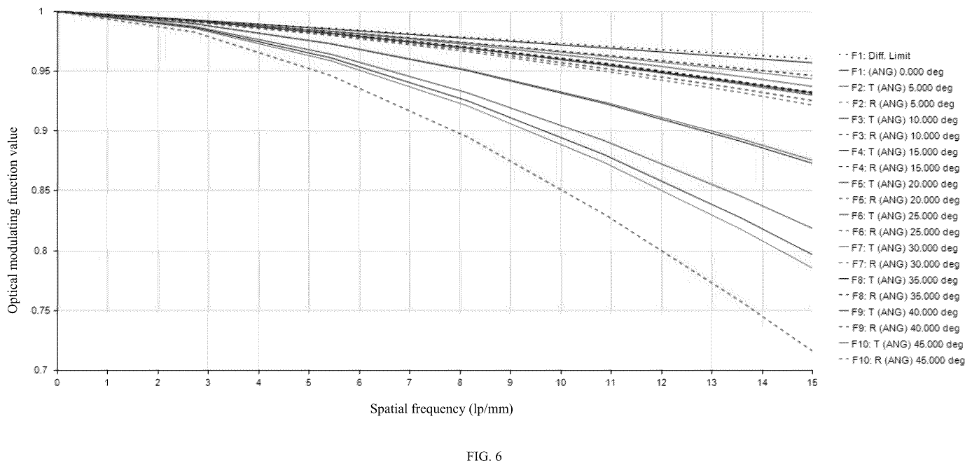

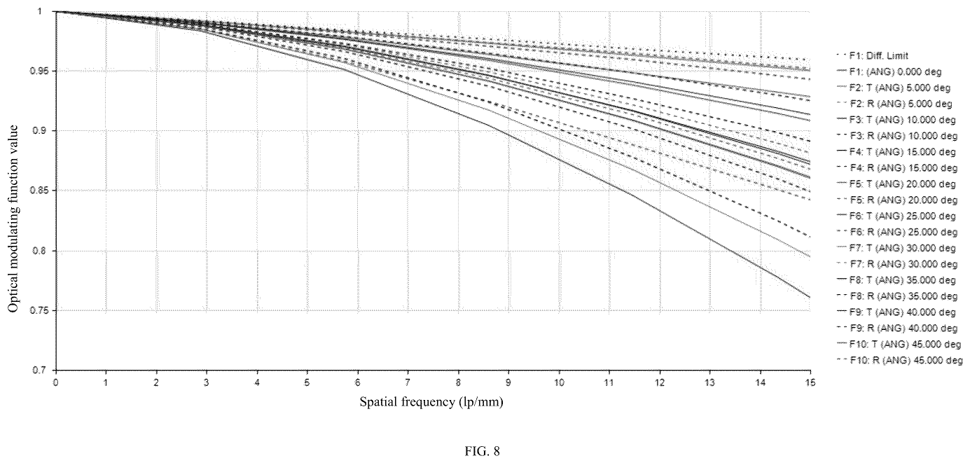

FIG. 6 is a modulating transfer function curve of the optical system of Embodiment 2 in the +2D state, and FIG. 8 is a modulating transfer function curve of the optical system of Embodiment 2 in the −5D state. It can be seen from FIG. 6 and FIG. 8 that the optical system in Embodiment 2 can achieve excellent imaging quality across different diopter states.

### Embodiment 3

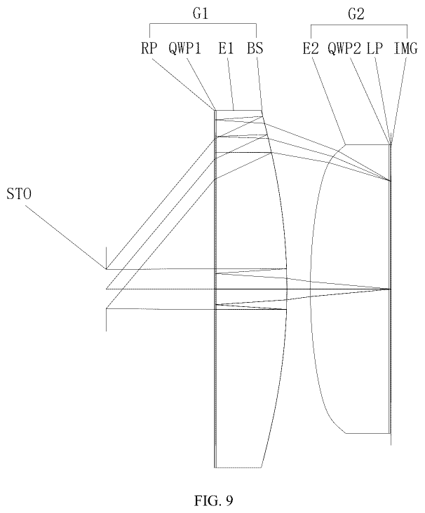

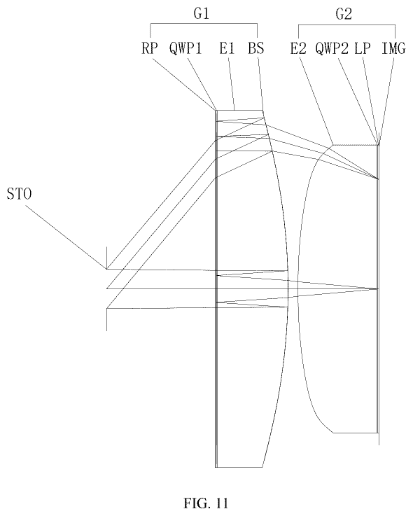

An optical system according to Embodiment 3 of the present disclosure is described below with reference to FIG. 9 to FIG. 12. FIG. 9 is a schematic structural diagram of the optical system in the +2D state according to Embodiment 3 of the present disclosure. FIG. 11 is a schematic structural diagram of the optical system in the −5D state according to Embodiment 3 of the present disclosure.

Referring to FIG. 9 and FIG. 11, the optical system of Embodiment 3 includes a diaphragm STO, a first element group G1, and a second element group G2. The first element group G1 includes a reflective polarizing element RP, a first quarter-wave plate QWP1, a first lens E1, and a partially reflective element BS, and the second element group G2 includes a second lens E2, a second quarter-wave plate QWP2, a polarizer LP, and a display IMG. The reflective polarizing element RP may be attached to the human eye-proximal surface of the first quarter-wave plate QWP1, and the first quarter-wave plate QWP1 may be attached to the human eye-proximal surface of the first lens E1. The partially reflective element BS may have semi-transmissive and semi-reflective functionality and be attached to the screen-proximal surface of the first lens E1. The second quarter-wave plate QWP2 may be attached to the screen-proximal surface of the second lens E2, the polarizer LP may be attached to the screen-proximal surface of the second quarter-wave plate QWP2, and the display IMG may be attached to the screen-proximal surface of the polarizer LP.

The first lens E1 has a positive refractive power, with the human eye-proximal surface being a planar surface and the screen-proximal surface being a convex surface. The second lens E2 has a positive refractive power, with the human eye-proximal surface being a convex surface and the screen-proximal surface being a planar surface.

In this embodiment, the light emitted by the display IMG may sequentially pass through the polarizer LP, the second quarter-wave plate QWP2, the second lens E2, the first lens E1, and the first quarter-wave plate QWP1 to reach the reflective polarizing element RP. A light beam may be then reflected at the reflective polarizing element RP and pass again through the first quarter-wave plate QWP1 and the first lens E1. The light beam may be reflected again at the partially reflective element BS on the screen-proximal surface of the first lens E1, and sequentially pass through the first lens E1, the first quarter-wave plate QWP1, and the reflective polarizing element RP, then pass through the diaphragm STO and finally exit towards the human eye side.

Table 7 shows basic parameters of the optical system of Embodiment 3, and each of the units of the radius of curvature and the thickness/distance is millimeter (mm).

TABLE 7

| | | Surface | Radius of | Thickness/ | Refractive | Abbe | Refractive/ | Conical |
|---|---|---|---|---|---|---|---|---|
| No. | Element name | Type | curvature | distance | index | number | reflective | coefficient |
| 0 | | Spherical | Infinite | D1 | | | Refractive | |
| | | surface | | | | | | |
| 1 | Diaphragm | Spherical | Infinite | 11.0000 | | | Refractive | |
| | (STO) | surface | | | | | | |
| 2 | Reflective | Spherical | Infinite | 0.1000 | 1.517 | 64.17 | Refractive | |
| | polarizing | surface | | | | | | |
| | element (RP) | | | | | | | |
| 3 | First quarter- | Spherical | Infinite | 0.1000 | 1.517 | 64.17 | Refractive | |
| | wave plate | surface | | | | | | |
| | (QWP1) | | | | | | | |
| 4 | First lens (E1) | Spherical | Infinite | 7.1903 | 1.810 | 41.00 | Refractive | |
| | | surface | | | | | | |
| 5 | Partially | Aspherical | −59.9020 | −7.1903 | 1.810 | 41.00 | Reflective | 2.7905 |
| | reflective | surface | | | | | | |
| | element (BS) | | | | | | | |
| 6 | | Spherical | Infinite | −0.1000 | 1.517 | 64.17 | Refractive | |
| | | surface | | | | | | |
| 7 | Reflective | Spherical | Infinite | 0.1000 | 1.517 | 64.17 | Reflective | |
| | polarizing | surface | | | | | | |
| | element (RP) | | | | | | | |
| 8 | First lens (E1) | Spherical | Infinite | 7.1903 | 1.810 | 41.00 | Refractive | |
| | | surface | | | | | | |
| 9 | | Aspherical | −59.9020 | D2 | | | Refractive | 2.7905 |
| | | surface | | | | | | |
| 10 | Second Lens | Aspherical | 62.3908 | 8.0000 | 1.544 | 55.92 | Refractive | 16.6530 |
| | (E2) | surface | | | | | | |
| 11 | Second | Spherical | Infinite | 0.1000 | 1.517 | 64.17 | Refractive | |
| | quarter-wave | surface | | | | | | |
| | plate (QWP2) | | | | | | | |
| 12 | Polarizer (LP) | Spherical | Infinite | 0.1000 | 1.517 | 64.17 | Refractive | |
| | | surface | | | | | | |
| 13 | | Spherical | Infinite | 0.0000 | | | Refractive | |
| | | surface | | | | | | |
| 14 | Display (IMG) | Spherical | Infinite | 0.0000 | | | Refractive | |
| | | surface | | | | | | |

In this embodiment, when the object distance D1 changes, the second element group G2 of the optical system may move along the optical axis to perform the diopter adjustment functionality. Table 8 shows the air separation D2 between the first lens and the second lens on the optical axis of the optical system of Embodiment 3 at different object distances D1. When the object distance D1 is equal to 500 mm, the optical system is in the first state (+2D state). When the object distance D1 is equal to −200 mm, the optical system is in the second state (−5D state). Each of the units in Table 8 is millimeter (mm).

TABLE 8

| | D1 | D2 |
|---|---|---|
| +2D state | 500.0000 | 2.3864 |
| −5D state | −200.0000 | 1.0000 |

Table 9 shows the high-order coefficients applicable to the aspherical mirror surfaces in Embodiment 3, and the surface types of the aspherical lenses may be defined by the formula (1) given in the above Embodiment 1.

TABLE 9

| Element | | | | | | | | | |
|---|---|---|---|---|---|---|---|---|---|
| name | Surface | A4 | A6 | A8 | A10 | A12 | A14 | A16 | A18 |
| First | Screen- | 2.8933E−06 | −2.2868E−09 | 2.9192E−11 | −4.7550E−14 | 1.9262E−17 | 0.0000E+00 | 0.0000E+00 | 0.0000E+00 |
| lens | proximal | | | | | | | | |
| | surface | | | | | | | | |
| Second | Human eye- | 1.8973E−05 | −2.9308E−07 | 1.2936E−09 | 0.0000E+00 | 0.0000E+00 | 0.0000E+00 | 0.0000E+00 | 0.0000E+00 |
| lens | proximal | | | | | | | | |
| | surface | | | | | | | | |

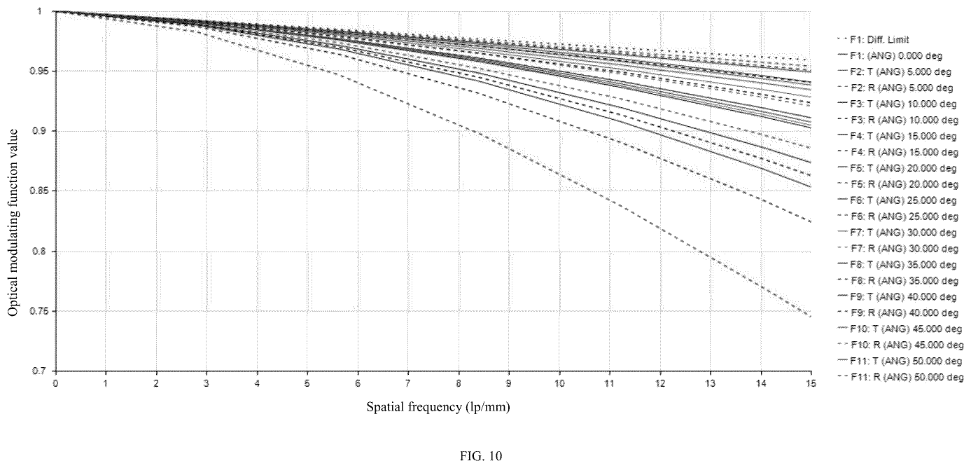

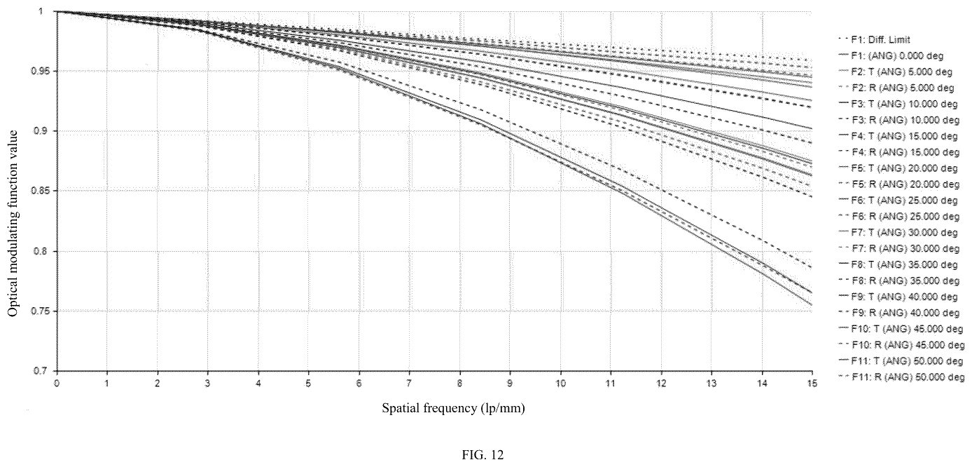

FIG. 10 is a modulating transfer function curve of the optical system of Embodiment 3 in the +2D state, and FIG. 12 is a modulating transfer function curve of the optical system of Embodiment 3 in the −5D state. It can be seen from FIG. 10 and FIG. 12 that the optical system in Embodiment 3 can achieve excellent imaging quality across different diopter states.

### Embodiment 4

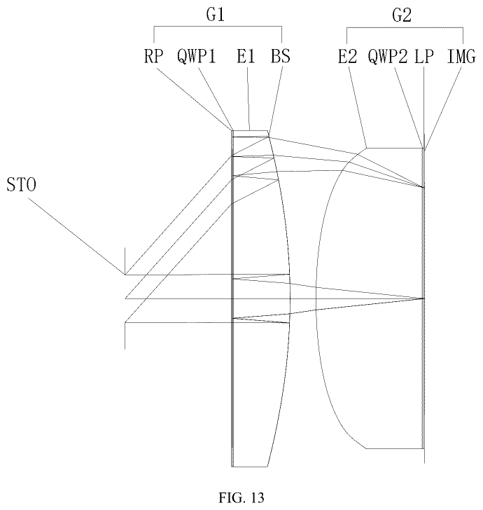

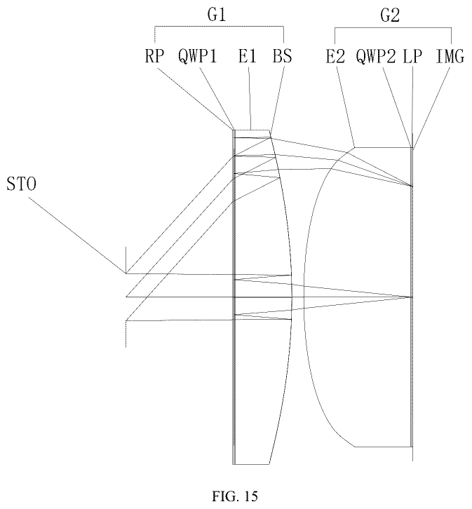

An optical system according to Embodiment 4 of the present disclosure is described below with reference to FIG. 13 to FIG. 16. FIG. 13 is a schematic structural diagram of the optical system in the +2D state according to Embodiment 4 of the present disclosure. FIG. 15 is a schematic structural diagram of the optical system in the −5D state according to Embodiment 4 of the present disclosure.

Referring to FIG. 13 and FIG. 15, the optical system of Embodiment 4 includes a diaphragm STO, a first element group G1, and a second element group G2. The first element group G1 includes a reflective polarizing element RP, a first quarter-wave plate QWP1, a first lens E1, and a partially reflective element BS, and the second element group G2 includes a second lens E2, a second quarter-wave plate QWP2, a polarizer LP, and a display IMG. The reflective polarizing element RP may be attached to the human eye-proximal surface of the first quarter-wave plate QWP1, and the first quarter-wave plate QWP1 may be attached to the human eye-proximal surface of the first lens E1. The partially reflective element BS may have semi-transmissive and semi-reflective functionality and be attached to the screen-proximal surface of the first lens E1. The second quarter-wave plate QWP2 may be attached to the screen-proximal surface of the second lens E2, the polarizer LP may be attached to the screen-proximal surface of the second quarter-wave plate QWP2, and the display IMG may be attached to the screen-proximal surface of the polarizer LP.

The first lens E1 has a positive refractive power, with the human eye-proximal surface being a planar surface and the screen-proximal surface being a convex surface. The second lens E2 has a positive refractive power, with the human eye-proximal surface being a convex surface and the screen-proximal surface being a planar surface.

In this embodiment, the light emitted by the display IMG may sequentially pass through the polarizer LP, the second quarter-wave plate QWP2, the second lens E2, the first lens E1, and the first quarter-wave plate QWP1 to reach the reflective polarizing element RP. A light beam may be then reflected at the reflective polarizing element RP and pass again through the first quarter-wave plate QWP1 and the first lens E1. The light beam may be reflected again at the partially reflective element BS on the screen-proximal surface of the first lens E1, and sequentially pass through the first lens E1, the first quarter-wave plate QWP1, and the reflective polarizing element RP, then pass through the diaphragm STO and finally exits towards the human eye side.

Table 10 shows basic parameters of the optical system of Embodiment 4, each of the units of the radius of curvature and the thickness/distance is millimeter (mm).

TABLE 10

| | | Surface | Radius of | Thickness/ | Refractive | Abbe | Refractive/ | Conical |
|---|---|---|---|---|---|---|---|---|
| No. | Element name | type | curvature | distance | index | number | reflective | coefficient |
| 0 | | Spherical | Infinite | D1 | | | Refractive | |
| | | surface | | | | | | |
| 1 | Diaphragm | Spherical | Infinite | 9.0000 | | | Refractive | |
| | (STO) | surface | | | | | | |
| 2 | Reflective | Spherical | Infinite | 0.1000 | 1.517 | 64.17 | Refractive | |
| | polarizing | surface | | | | | | |
| | element (RP) | | | | | | | |
| 3 | First quarter- | Spherical | Infinite | 0.1000 | 1.517 | 64.17 | Refractive | |
| | wave plate | surface | | | | | | |
| | (QWP1) | | | | | | | |
| 4 | First lens (E1) | Spherical | Infinite | 4.7897 | 1.639 | 23.52 | Refractive | |
| | | surface | | | | | | |
| 5 | Partially | Aspherical | −50.3037 | −4.7897 | 1.639 | 23.52 | Reflective | 2.9593 |
| | reflective | surface | | | | | | |
| | element (BS) | | | | | | | |
| 6 | | Spherical | Infinite | −0.1000 | 1.517 | 64.17 | Refractive | |
| | | surface | | | | | | |
| 7 | Reflective | Spherical | Infinite | 0.1000 | 1.517 | 64.17 | Reflective | |
| | polarizing | surface | | | | | | |
| | element (RP) | | | | | | | |
| 8 | First lens (E1) | Spherical | Infinite | 4.7897 | 1.639 | 23.52 | Refractive | |
| | | surface | | | | | | |
| 9 | | Aspherical | −50.3037 | D2 | | | Refractive | 2.9593 |
| | | surface | | | | | | |
| 10 | Second Lens | Aspherical | 39.5956 | 9.0000 | 1.544 | 55.92 | Refractive | 8.3873 |
| | (E2) | surface | | | | | | |
| 11 | Second | Spherical | Infinite | 0.1000 | 1.517 | 64.17 | Refractive | |
| | quarter-wave | surface | | | | | | |
| | plate (QWP2) | | | | | | | |
| 12 | Polarizer (LP) | Spherical | Infinite | 0.1000 | 1.517 | 64.17 | Refractive | |
| | | surface | | | | | | |
| 13 | | Spherical | Infinite | 0.0000 | | | Refractive | |
| | | surface | | | | | | |
| 14 | Display (IMG) | Spherical | Infinite | 0.0000 | | | Refractive | |
| | | surface | | | | | | |

In this embodiment, when the object distance D1 changes, the second element group G2 of the optical system may move along the optical axis to perform the diopter adjustment functionality. Table 11 shows the air separation D2 between the first lens and the second lens on the optical axis of the optical system of Embodiment 4 at different object distances D1. When the object distance D1 is equal to 500 mm, the optical system is in the first state (+2D state). When the object distance D1 is equal to −200 mm, the optical system is in the second state (−5D state). Each of the units in Table 11 is millimeter (mm).

TABLE 11

| | D1 | D2 |
|---|---|---|
| +2D state | 500.0000 | 2.1933 |
| −5D state | −200.0000 | 1.0000 |

Table 12 shows the high-order coefficients applicable to the aspherical mirror surfaces in Embodiment 4, and the surface types of the aspherical lenses may be defined by the formula (1) given in the above Embodiment 1.

TABLE 12

| Element | | | | | | | | | |
|---|---|---|---|---|---|---|---|---|---|
| name | Surface | A4 | A6 | A8 | A10 | A12 | A14 | A16 | A18 |
| First | Screen- | 5.7070E−06 | −7.2912E−09 | 1.2163E−10 | −4.1072E−13 | 5.2266E−16 | 0.0000E+00 | 0.0000E+00 | 0.0000E+00 |
| lens | proximal | | | | | | | | |
| | surface | | | | | | | | |
| Second | Human eye- | 3.3403E−05 | −2.6483E−07 | 1.6918E−09 | 0.0000E+00 | 0.0000E+00 | 0.0000E+00 | 0.0000E+00 | 0.0000E+00 |
| lens | proximal | | | | | | | | |
| | surface | | | | | | | | |

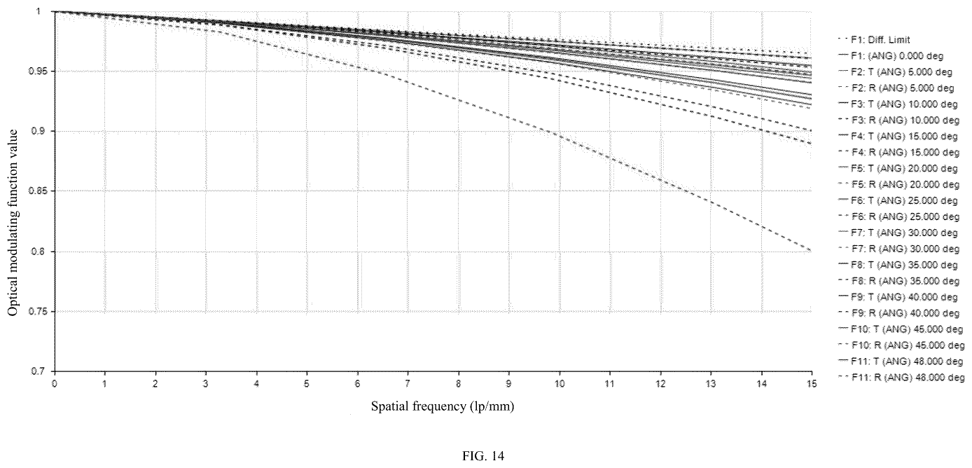

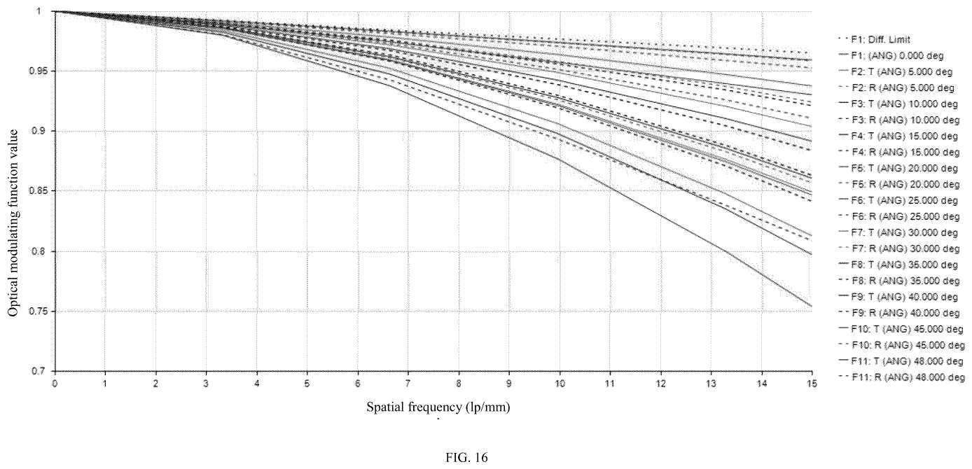

FIG. 14 is a modulating transfer function curve of the optical system of Embodiment 4 in the +2D state, and FIG. 16 is a modulating transfer function curve of the optical system of Embodiment 4 in the −5D state. It can be seen from FIG. 14 and FIG. 16 that the optical system in Embodiment 4 can achieve excellent imaging quality across different diopter states.

### Embodiment 5

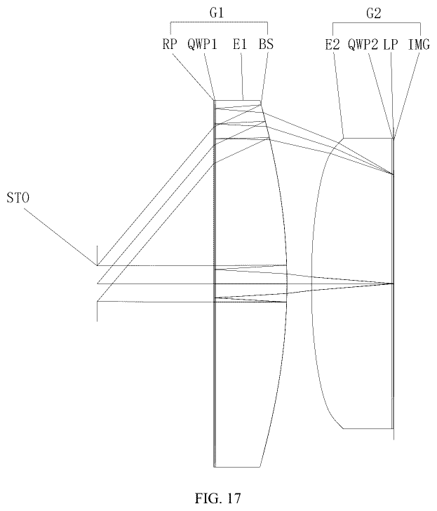

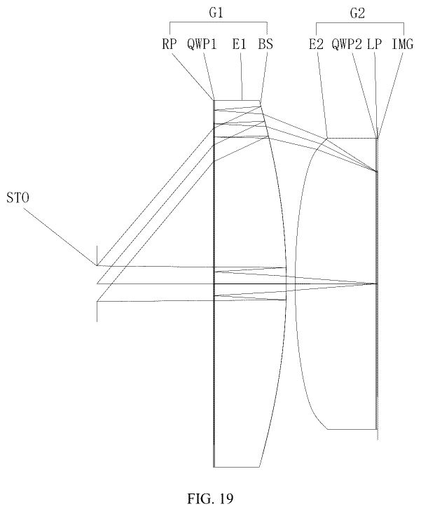

An optical system according to Embodiment 5 of the present disclosure is described below with reference to FIG. 17 to FIG. 20. FIG. 17 is a schematic structural diagram of the optical system in the +2D state according to Embodiment 5 of the present disclosure. FIG. 19 is a schematic structural diagram of the optical system in the −5D state according to Embodiment 5 of the present disclosure.

Referring to FIG. 17 and FIG. 19, the optical system of Embodiment 5 includes a diaphragm STO, a first element group G1, and a second element group G2. The first element group G1 includes a reflective polarizing element RP, a first quarter-wave plate QWP1, a first lens E1, and a partially reflective element BS, and the second element group G2 includes a second lens E2, a second quarter-wave plate QWP2, a polarizer LP, and a display IMG. The reflective polarizing element RP may be attached to the human eye-proximal surface of the first quarter-wave plate QWP1, and the first quarter-wave plate QWP1 may be attached to the human eye-proximal surface of the first lens E1. The partially reflective element BS may have semi-transmissive and semi-reflective functionality and be attached to the screen-proximal surface of the first lens E1. The second quarter-wave plate QWP2 may be attached to the screen-proximal surface of the second lens E2, the polarizer LP may be attached to the screen-proximal surface of the second quarter-wave plate QWP2, and the display IMG may be attached to the screen-proximal surface of the polarizer LP.

The first lens E1 has a positive refractive power, with the human eye-proximal surface being a planar surface and the screen-proximal surface being a convex surface. The second lens E2 has a positive refractive power, with the human eye-proximal surface being a convex surface and the screen-proximal surface being a planar surface.

In this embodiment, the light emitted by the display IMG may sequentially pass through the polarizer LP, the second quarter-wave plate QWP2, the second lens E2, the first lens E1, and the first quarter-wave plate QWP1 to reach the reflective polarizing element RP. A light beam may be then reflected at the reflective polarizing element RP and passes again through the first quarter-wave plate QWP1 and the first lens E1. The light beam may be reflected again at the partially reflective element BS on the screen-proximal surface of the first lens E1, and sequentially pass through the first lens E1, the first quarter-wave plate QWP1, and the reflective polarizing element RP, then pass through the diaphragm STO and finally exits towards the human eye side.

Table 13 shows basic parameters of the optical system of Embodiment 5, each of the units of the radius of curvature and the thickness/distance is millimeter (mm).

TABLE 13

| | | Surface | Radius of | Thickness | Refractive | Abbe | /reflective | Conical |
|---|---|---|---|---|---|---|---|---|
| No. | Element name | type | curvature | /distance | index | number | Refractive | coefficient |
| 0 | | Spherical | Infinite | D1 | | | Refractive | |
| | | surface | | | | | | |
| 1 | Diaphragm | Spherical | Infinite | 13.0000 | | | Refractive | |
| | (STO) | surface | | | | | | |
| 2 | Reflective | Spherical | Infinite | 0.1000 | 1.517 | 64.17 | Refractive | |
| | polarizing | surface | | | | | | |
| | element (RP) | | | | | | | |
| 3 | First quarter- | Spherical | Infinite | 0.1000 | 1.517 | 64.17 | Refractive | |
| | wave plate | surface | | | | | | |
| | (QWP1) | | | | | | | |
| 4 | First lens (E1) | Spherical | Infinite | 7.9973 | 1.810 | 41.00 | Refractive | |
| | | surface | | | | | | |
| 5 | Partially | Aspherical | −66.6356 | −7.9973 | 1.810 | 41.00 | Reflective | 3.5114 |
| | reflective | surface | | | | | | |
| | element (BS) | | | | | | | |
| 6 | | Spherical | Infinite | −0.1000 | 1.517 | 64.17 | Refractive | |
| | | surface | | | | | | |
| 7 | Reflective | Spherical | Infinite | 0.1000 | 1.517 | 64.17 | Reflective | |
| | polarizing | surface | | | | | | |
| | element (RP) | | | | | | | |
| 8 | First Lens (E1) | Spherical | Infinite | 7.9973 | 1.810 | 41.00 | Refractive | |
| | | surface | | | | | | |
| 9 | | Aspherical | −66.6356 | D2 | | | Refractive | 3.5114 |
| | | surface | | | | | | |
| 10 | Second Lens | Aspherical | 86.3340 | 9.0000 | 1.544 | 55.92 | Refractive | 25.3678 |
| | (E2) | surface | | | | | | |
| 11 | Second | Spherical | Infinite | 0.1000 | 1.517 | 64.17 | Refractive | |
| | quarter-wave | surface | | | | | | |
| | plate (QWP2) | | | | | | | |
| 12 | Polarizer (LP) | Spherical | Infinite | 0.1000 | 1.517 | 64.17 | Refractive | |
| | | surface | | | | | | |
| 13 | | Spherical | Infinite | 0.0000 | | | Refractive | |
| | | surface | | | | | | |
| 14 | Display (IMG) | Spherical | Infinite | 0.0000 | | | Refractive | |
| | | surface | | | | | | |

In this embodiment, when the object distance D1 changes, the second element group G2 of the optical system may move along the optical axis to perform the diopter adjustment functionality. Table 14 shows the air separation D2 between the first lens and the second lens on the optical axis of the optical system of Embodiment 5 at different object distances D1. When the object distance D1 is equal to 500 mm, the optical system is in the first state (+2D state). When the object distance D1 is equal to −200 mm, the optical system is in the second state (−5D state). Each of the units in Table 14 is millimeter (mm).

TABLE 14

| | D1 | D2 |
|---|---|---|
| +2D state | 500.0000 | 2.7364 |
| −5D state | −200.0000 | 1.0000 |

Table 15 shows the high-order coefficients applicable to the aspherical mirror surfaces in Embodiment 5, and the surface types of the aspherical lenses may be defined by the formula (1) given in the above Embodiment 1.

TABLE 15

| Element | | | | | | | | | |
|---|---|---|---|---|---|---|---|---|---|
| name | Surface | A4 | A6 | A8 | A10 | A12 | A14 | A16 | A18 |
| First | Screen- | 2.8237E−06 | −4.0411E−09 | 2.4381E−11 | −3.7137E−14 | 2.1215E−17 | 0.0000E+00 | 0.0000E+00 | 0.0000E+00 |
| lens | proximal | | | | | | | | |
| | surface | | | | | | | | |
| Second | Human eye- | 2.8805E−05 | −2.3764E−07 | 7.0914E−10 | 0.0000E+00 | 0.0000E+00 | 0.0000E+00 | 0.0000E+00 | 0.0000E+00 |
| lens | proximal | | | | | | | | |
| | surface | | | | | | | | |

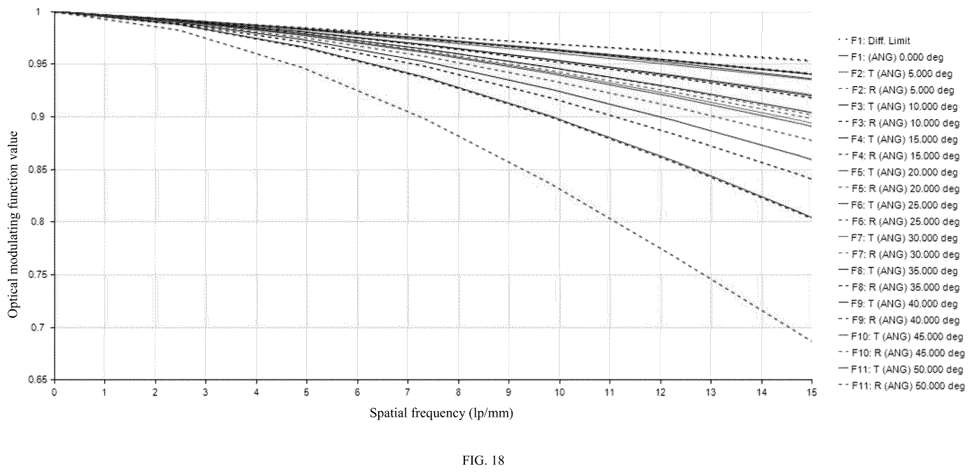

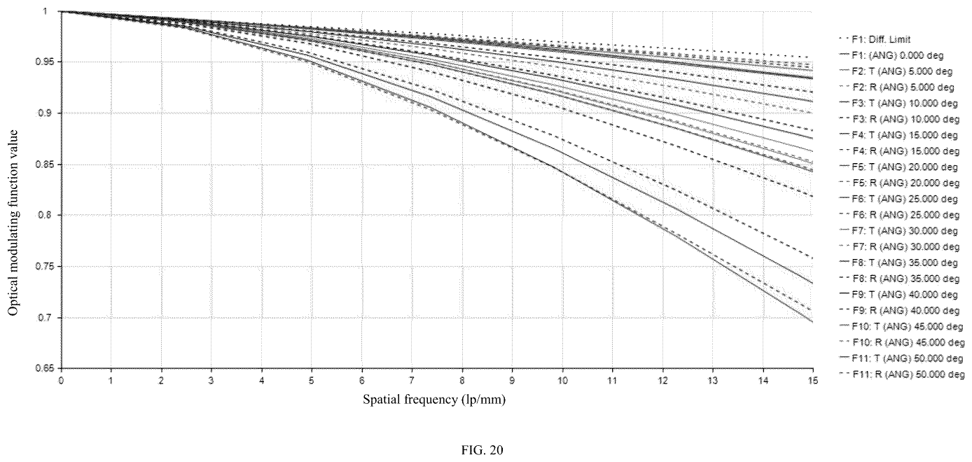

FIG. 18 is a modulating transfer function curve of the optical system of Embodiment 5 in the +2D state, and FIG. 20 is a modulating transfer function curve of the optical system of Embodiment 5 in the −5D state. It can be seen from FIG. 18 and FIG. 20 that the optical system in Embodiment 5 can achieve excellent imaging quality across different diopter states.

Table 16 shows some parameter values in millimeters (mm) of the optical systems according to Embodiments 1 to 5.

TABLE 16

embodiments

| Parameters | 1 | 2 | 3 | 4 | 5 |
|---|---|---|---|---|---|
| fm (mm) | 12.49 | 14.26 | 14.20 | 12.64 | 15.94 |
| fn (mm) | 12.26 | 13.99 | 14.04 | 12.45 | 15.77 |
| f1 (mm) | 75.03 | 86.41 | 73.95 | 78.70 | 82.27 |
| f2 (mm) | 54.40 | 72.10 | 114.71 | 72.80 | 158.73 |
| fz1 (mm) | 75.03 | 86.41 | 73.95 | 78.70 | 82.27 |
| fz2 (mm) | 54.40 | 72.10 | 114.71 | 72.80 | 158.73 |
| EPD (mm) | 4.00 | 4.00 | 4.00 | 4.00 | 4.00 |
| TDm(mm) | 14.48 | 17.14 | 17.58 | 15.98 | 19.73 |
| TDn(mm) | 13.37 | 15.62 | 16.19 | 14.79 | 18.00 |
| T12m (mm) | 2.11 | 2.52 | 2.39 | 2.19 | 2.74 |
| T12n (mm) | 1.00 | 1.00 | 1.00 | 1.00 | 1.00 |
| ΔL (mm) | 1.11 | 1.52 | 1.39 | 1.19 | 1.74 |
| Δf (mm) | 0.23 | 0.27 | 0.16 | 0.19 | 0.17 |
| fm (mm) | 12.49 | 14.26 | 14.20 | 12.64 | 15.94 |
| fn (mm) | 12.26 | 13.99 | 14.04 | 12.45 | 15.77 |

In summary, the optical systems according to Embodiments 1 to 5 satisfy the relationships shown in Table 17.

TABLE 17

| | embodiments | | | | |
|---|---|---|---|---|---|
| Conditions | 1 | 2 | 3 | 4 | 5 |
| fz1/fz2 | 1.38 | 1.20 | 0.64 | 1.08 | 0.52 |
| (CT2 + CTQ2 + CTL)/ΔL | 5.60 | 5.40 | 5.91 | 7.71 | 5.30 |
| (f2/f1) × Δf (mm) | 0.17 | 0.23 | 0.25 | 0.17 | 0.32 |
| (R2/R3) × ΔL (mm) | −1.79 | −2.14 | −1.33 | −1.52 | −1.34 |
| fm/T12m | 5.93 | 5.66 | 5.95 | 5.76 | 5.82 |
| R3/TDn | 2.21 | 2.51 | 3.85 | 2.68 | 4.80 |
| fn/(CT1 + CTR + CTQ1) | 1.87 | 2.05 | 1.90 | 2.50 | 1.92 |
| T12n/Δf | 4.31 | 3.65 | 6.16 | 5.32 | 6.00 |
| (TDm + TDn)/EPD | 6.96 | 8.19 | 8.44 | 7.69 | 9.43 |
| CT2/(T12m + T12n) | 1.93 | 2.27 | 2.36 | 2.82 | 2.41 |
| (f1/N1)/TDm | 3.16 | 3.08 | 2.32 | 3.00 | 2.30 |
| (f2/V2)/ΔL | 0.88 | 0.85 | 1.48 | 1.09 | 1.63 |
| (fz1/CT1) × Δf(mm) | 2.73 | 3.58 | 1.67 | 3.09 | 1.71 |
| (fz2/R3) × ΔL(mm) | 2.03 | 2.79 | 2.55 | 2.19 | 3.19 |
| f2/(fm + fn) | 2.20 | 2.55 | 4.06 | 2.90 | 5.01 |

The present disclosure further provides an optical device, which may be an independent projection device such as a projector, or a projection module integrated on a mobile electronic device such as a VR. The optical device is equipped with the optical system described above.

The above description is only the embodiments of the present disclosure and the explanation of the applied technical principle. It should be understood by those skilled in the art that the protection scope involved in the present disclosure is not limited to the technical solutions formed by a specific combination of the above technical features and should also cover other technical solutions formed by any combination of the above technical features or equivalent features thereof without departing from the concept of the present disclosure. For example, the protection scope involved in the present disclosure cover the technical solutions formed by replacing the above technical features with that having similar functions disclosed in the present disclosure (but not limited to thereto).

What is claimed is:

1. An optical system, comprising a first element group and a second element group sequentially along an optical axis from a first side to a second side,
wherein the first element group comprises a reflective polarizing element, a first quarter-wave plate, a first lens, and a partially reflective element;
the second element group comprises a second lens, a second quarter-wave plate, a polarizer, and a display;
the reflective polarizing element, the first quarter-wave plate, the first lens, and the partially reflective element are cemented sequentially from the first side to the second side;
the second lens, the second quarter-wave plate, the polarizer, and the display are cemented sequentially from the first side to the second side;
the first lens has a positive refractive power, with a first surface being a planar surface and a second surface being a convex surface;
the second lens has a positive refractive power, with a first surface being a convex surface and a second surface being a planar surface;
the second element group is movable between the first side and the second side along the optical axis to adjust a separation distance between the first element group and the second element group on the optical axis, so as to switch the optical system between a first state and a second state; and
the optical system is configured to satisfy the following relationships: 0.5<fz1/fz2<1.4 and 5.30≤(CT2+CTQ2+CTL)/ΔL≤7.71, wherein fz1 represents a combined focal length of the reflective polarizing element, the first quarter-wave plate, and the first lens; fz2 represents a combined focal length of the second lens, the second quarter-wave plate, and the polarizer; CT2 represents a central thickness of the second lens on the optical axis; CTQ2 represents a central thickness of the second quarter-wave plate on the optical axis; CTL represent a central thickness of the polarizer on the optical axis; and ΔL represents a variation in the separation distance between the first element group and the second element group on the optical axis when the optical system is in the first state and the second state.

2. The optical system of claim 1, configured to satisfy the following relationship: 0.15 mm<(f2/f1)×Δf<0.35 mm, wherein f2 represents an effective focal length of the second lens, f1 represents an effective focal length of the first lens, and Δf represents a variation in an effective focal length of the optical system between the first state and the second state.

3. The optical system of claim 1, configured to satisfy the following relationship: −2.15 mm<(R2/R3)×ΔL<−1.30 mm, wherein R2 represents a radius of curvature of the second surface of the first lens, and R3 represents a radius of curvature of the first surface of the second lens.

4. The optical system of claim 1, configured to satisfy the following relationship: 5.66≤fm/T12m≤5.95, wherein fm represents an effective focal length of the optical system in the first state, and T12m represents a distance between the second surface of the first lens and the first surface of the second lens on the optical axis when the optical system is in the first state.

5. The optical system of claim 1, configured to satisfy the following relationship: 2.21≤R3/TDn≤4.80, wherein R3 represents a radius of curvature of the first surface of the second lens, and TDn represents a distance between the first surface of the first lens and the second surface of the second lens on the optical axis when the optical system is in the second state.

6. The optical system of claim 1, configured to satisfy the following relationship: 1.87≤fn/(CT1+CTR+CTQ1)≤2.50, wherein fn represents an effective focal length of the optical system in the second state, CT1 represents a central thickness of the first lens on the optical axis, CTR represents a central thickness of the reflective polarizing element on the optical axis, and CTQ1 represents a central thickness of the first quarter-wave plate on the optical axis.

7. The optical system of claim 1, configured to satisfy the following relationship: 3.65≤T12n/Δf≤6.16, wherein T12n represents a distance between the second surface of the first lens and the first surface of the second lens on the optical axis when the optical system is in the second state, and Δf represents a variation in an effective focal length of the optical system between the first state and the second state.

8. The optical system of claim 1, configured to satisfy the following relationship: 6.95<(TDm+TDn)/EPD<9.45, wherein TDm represents a distance between the first surface of the first lens and the second surface of the second lens on the optical axis when the optical system is in the first state, TDn represents a distance between the first surface of the first lens and the second surface of the second lens on the optical axis when the optical system is in the second state, and EPD represents an entrance pupil diameter of the optical system.

9. The optical system of claim 1, configured to satisfy the following relationship: 1.93≤CT2/(T12m+T12n)≤2.82, wherein T12m represents a distance between the second surface of the first lens and the first surface of the second lens on the optical axis when the optical system is in the first state, and T12n represents a distance between the second surface of the first lens and the first surface of the second lens on the optical axis when the optical system is in the second state.

10. The optical system of claim 1, configured to satisfy the following relationship: 2.30≤(f1/N1)/TDm≤3.16, wherein f1 represents an effective focal length of the first lens, N1 represents a refractive index of the first lens, and TDm represents a distance between the first surface of the first lens and the second surface of the second lens on the optical axis when the optical system is in the first state.

11. The optical system of claim 1, configured to satisfy the following relationship: 0.85≤(f2/V2)/ΔL≤1.63, wherein f2 represents an effective focal length of the second lens, and V2 represents a dispersion coefficient of the second lens.

12. The optical system of claim 1, configured to satisfy the following relationship: 1.67 mm≤(fz1/CT1)×Δf≤3.58 mm, wherein CT1 represents a central thickness of the first lens on the optical axis, and Δf represents a variation in an effective focal length of the optical system between the first state and the second state.

13. The optical system of claim 1, configured to satisfy the following relationship: 2.0 mm<(fz2/R3)×ΔL<3.2 mm, wherein R3 represents a radius of curvature of the first surface of the second lens.

14. The optical system of claim 1, configured to satisfy the following relationship: 2.20≤f2/(fm+fn)≤5.01, wherein f2 represents an effective focal length of the second lens, fm represents an effective focal length of the optical system in the first state, and fn represents an effective focal length of the optical system in the second state.

15. An optical device, comprising the optical system of claim 1.

16. The optical device of claim 15, wherein the optical system is configured to satisfy the following relationship: 0.15 mm<(f2/f1)×Δf<0.35 mm, f2 represents an effective focal length of the second lens, f1 represents an effective focal length of the first lens, and Δf represents a variation in an effective focal length of the optical system between the first state and the second state.

17. The optical device of claim 15, wherein the optical system is configured to satisfy the following relationship: −2.15 mm<(R2/R3)×ΔL<−1.30 mm, R2 represents a radius of curvature of the second surface of the first lens, and R3 represents a radius of curvature of the first surface of the second lens.

18. The optical device of claim 15, wherein the optical system is configured to satisfy the following relationship: 5.66≤fm/T12m≤5.95, fm represents an effective focal length of the optical system in the first state, and T12m represents a distance between the second surface of the first lens and the first surface of the second lens on the optical axis when the optical system is in the first state.

19. The optical device of claim 15, wherein the optical system is configured to satisfy the following relationship: 2.21≤R3/TDn≤4.80, R3 represents a radius of curvature of the first surface of the second lens, and TDn represents a distance between the first surface of the first lens and the second surface of the second lens on the optical axis when the optical system is in the second state.

20. The optical device of claim 15, wherein the optical system is configured to satisfy the following relationship: 1.87≤fn/(CT1+CTR+CTQ1)≤2.50, fn represents an effective focal length of the optical system in the second state, CT1 represents a central thickness of the first lens on the optical axis, CTR represents a central thickness of the reflective polarizing element on the optical axis, and CTQ1 represents a central thickness of the first quarter-wave plate on the optical axis.
